(19) United States
(12) Patent Application Publication
(10) Pub. No.: US 2009/0094290 A1
(43) Pub. Date: Apr. 9, 2009

(54) DOCUMENT MANAGEMENT SERVER, MOBILE TERMINAL AND DOCUMENT MANAGEMENT SYSTEM

(76) Inventor: Yoshiko SHIIMORI, Tokyo (JP)

Correspondence Address: BIRCH STEWART KOLASCH & BIRCH, PO BOX 747, FALLS CHURCH, VA, 22040-0747, US

(21) Appl. No.: 12/238,210

(22) Filed: Sep. 25, 2008

(30) Foreign Application Priority Data
Sep. 27, 2007 (JP) 2007-252245

(51) Int. Cl. G06F 17/30

(52) U.S. Cl. 707/200; 707/E17.01

(57) ABSTRACT

When a user of a mobile phone browses a document in a document management server via a network, the user can input information (sticker information) on the browsed document and send it to the document management server. The document management server relates the received information to the pertinent document file when storing the information. Thus, when a document is browsed from a mobile device, information on the document can be easily left and the information left can be browsed later.

### BACKGROUND OF THE INVENTION

1. Field of the Invention

The present invention relates to a document management server, a mobile terminal and a document management system, and more particularly to a document management server, a mobile terminal and a document management system which allows a user to leave comments when the user reads a document on a mobile terminal and to read the comments.

2. Description of the Related Art

Various items of information affluent in business enterprises are diversified including not only documents but also images and Web contents, and moreover are increasing day to day. Enterprise Content Management (ECM) solutions intended to place these contents in enterprises under unified management and thereby to vitalize and enhance the efficiency of business activities are coming into expanding use. However, though these ECM solutions can prove most effective in outward situations, such as making presentations or engaging in sales activities, there scarcely are solutions which are suitable for a mobile environment in which the user is out of office.

Japanese Patent Application Laid-Open No. 2003-316677 discloses a technique by which data for mobile terminal use selected with an information processing device are distributed to mobile terminal devices via a communication network. This technique enables, when data for mobile terminal use are to be selected out of a plurality of sets of data, the data to be easily looked at and selected without requiring complex processing.

### SUMMARY OF THE INVENTION

Although products embodying considerations for out-of-office sales activities using a mobile phone (mobile terminal) are becoming available, such as those using the technique described in Japanese Patent Application Laid-Open No. 2003-316677, they permit browsing usually not updating out of office, and therefore fail to fully satisfy their users' requirements. On the other hand, many users think what they want to do on a mobile phone is to leave a memo on a document, such as putting a sticker onto the page for later reference. The present invention, attempted in view of these circumstances, is intended to provide a document management server, a mobile terminal and a document management system which, when a user looks on a mobile phone at any of diverse documents (such as various formatted documents and images) under unified management, allows the user to write comments and read the written comments afterwards as if he or she were putting a sticker onto a page.

In order to achieve the object stated above, according to a first aspect of the invention, a document management server for managing documents in various formats arbitrarily created, includes: a device which allows a mobile terminal connected to the document management server via a communication network to browse an arbitrary document in the document management server; a device which acquires sticker information on an electronic sticker attached to a document browsed by the mobile terminal; and a device which manages the browsed document and the acquired sticker information associated with each other.

In this way, sticker information on an electronic sticker attached into a document can be managed easily.

According to a second aspect of the invention, in the document management server according to the first aspect, the device which allows to browse documents comprises a device which enables the sticker information to be browsed together with the document.

In this way, it becomes possible to browse sticker information on an electronic sticker attached to the document.

According to a third aspect of the invention, in the document management server according to the first or second aspect, the sticker information includes at least one of a position, type, text information, name of creator, date and time of creation, and level of importance of the electronic sticker.

In this way, necessary information can be left.

According to a fourth aspect of the invention, in the document management server according to the third aspect, the device which enables the sticker information to be browsed comprises at least one of: a device for browsing sticker information items on electronic sticker attached in the same position, a device for browsing sticker information items on electronic sticker attached by the same creator, a device for browsing sticker information items on electronic sticker with respect to each creator, a device for browsing sticker information items on electronic sticker attached on the same date of creation, a device for browsing sticker information items on electronic sticker in the order of the date of creation, and a device for browsing sticker information items on electronic sticker with respect to each level of importance.

In this way, it is possible to browse only the necessary sticker information.

In order to achieve the object stated above, according to a fifth aspect of the invention, a mobile terminal which is connected via a communication network to the document management server according to any of the first to fourth aspects and can browse an arbitrary document in the document management server, the mobile terminal includes: a device which attaches an electronic sticker to a browsed document; and a device which outputs sticker information on the electronic sticker to the document management server.

In this way, it is possible to easily leave sticker information on a document.

According to a sixth aspect of the invention, in the mobile terminal according to the fifth aspect, the sticker information includes at least one of a position, type, text information, name of creator, date and time of creation, and level of importance of the electronic sticker.

In this way, necessary information can be left.

In order to achieve the object stated above, according to a seventh aspect of the invention, a document management system includes a document management server for managing documents in various formats arbitrarily created, and a mobile terminal connected via a communication network to the document management server and browse an arbitrary document in the document management server. And, in the document management system, the document management server includes: a device which allows a mobile terminal connected to the document management server via a communication network to browse an arbitrary document in the document management server; a device which acquires sticker information on an electronic sticker attached to a document browsed by the mobile terminal; and a device which manages the browsed document and the acquired sticker information associated with each other. Meanwhile, in the document management system, the mobile terminal includes: a device which attaches an electronic sticker to a browsed document; and a device which outputs sticker information on the electronic sticker to the document management server.

In this way, sticker information on electronic sticker attached into a document can be easily managed by a document management server, and sticker information on electronic sticker attached into a document can be browsed from a mobile terminal.

A method which comprises steps and functions performed by the document management server or the mobile terminal according any of the aspects of the present invention may also achieve the object of the present invention.

In addition, a program causing a computer to perform the functions performed by the document management server or the mobile terminal according to any of the aspects may also achieve the object of the present invention by causing the computer on which the program is installed to execute the program. The program may be recorded on a recording medium.

According to the invention, when browsing various documents under integrated management on a mobile phone, a user of the mobile phone can leave a comment (electronic sticker) on the document as if the user were putting a sticker onto a paper document, and, afterwards, the user can browse the left the electronic sticker. Accordingly, a document management server, a mobile terminal and a document management system that can make ECM solutions more extensively useful, can be provided.

### BRIEF DESCRIPTION OF THE DRAWINGS

FIG. 1 is a system diagram showing the overall configuration of a document management system to which the present invention is applicable;

FIG. 2 is a system diagram showing a processing device related to the registration of a document, browse of the registered document and preparation of marking;

FIG. 3 shows a typical data structure of a document management table 82;

FIG. 4 shows a typical data structure of a creator management table;

FIG. 5 is a sequence chart showing in a time series processing of marking in a random position in a browsed document;

FIG. 6 shows screens on the display device of a mobile phone 14 when marking is accomplished in a random position in a browsed document;

FIG. 7 shows the data structure of a marking type management table 84;

FIG. 8 shows a typical data structure of a marking history management table 86;

FIG. 9 is a sequence chart showing in a time series processing of browsing marking in a document being browsed;

FIG. 10 shows screens on the display device of the mobile phone 14 when marking is browsed in a document being browsed; and

FIGS. 11A to 11C show screens on the display device of the mobile phone 14 when the marking to be browsed is designated.

### DETAILED DESCRIPTION OF THE PREFERRED EMBODIMENTS

A document management system which is a preferred embodiment of the present invention will be described below with reference to the accompanying drawings.

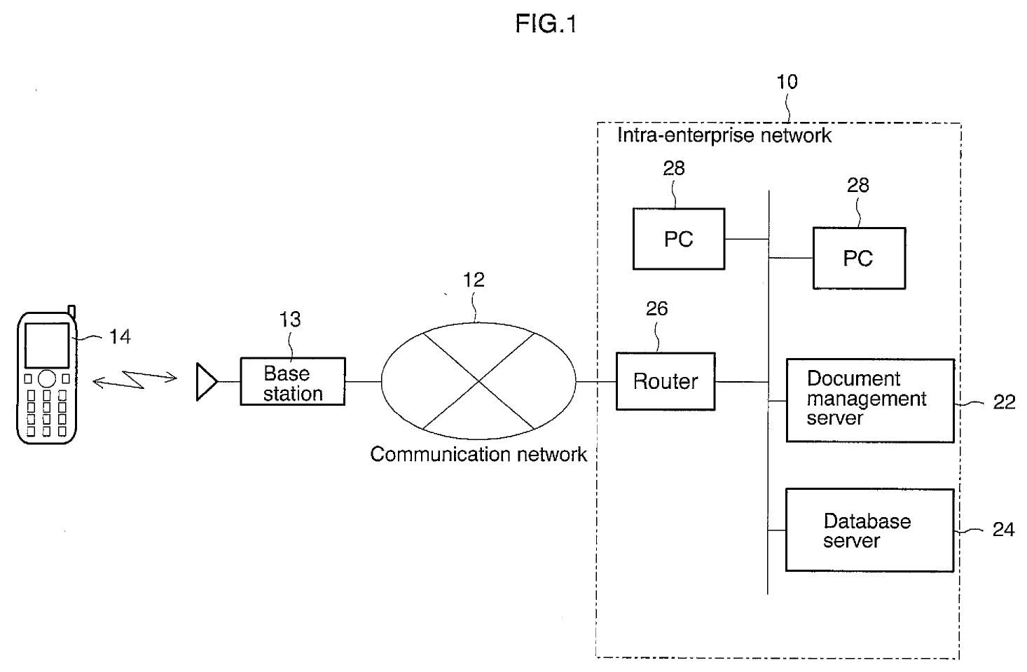

FIG. 1 is a system diagram showing the overall configuration of a document management system to which the present invention is applicable. The document management system illustrated here, which is a system for unified management of various kinds of information in an enterprise as an Enterprise Content Management (ECM) solution for instance, comprises an intra-enterprise network (intranet) 10 laid within an enterprise, a communication network 12 laid outside the enterprise such as the Internet, a mobile phone (mobile terminal) 14 connectable to the communication network 12 via a base station 13 and so forth. Although the invention also is applicable to another type of mobile terminal or personal computer such as a PDA or a laptop type personal computer instead of the mobile phone 14, the description of this embodiment will presuppose the use of a mobile phone.

The intra-enterprise network 10 comprises a document management server 22, a database server 24, a router 26 and personal computers (PCs) 28, 28, . . . of individual employees arranged within the enterprise. These equipment items of the intra-enterprise network 10 can be connected to the communication network 12 outside the enterprise via the router 26.

The mobile phone 14, representing in the drawing any one of the mobile phones owned by the employees or the like, can be connected to the communication network 12 via the base station 13. Its connection to the communication network 12 enables the mobile phone to access the document management server 22 of the intra-enterprise network 10 and to acquire and read information distributed from the document management server 22 in a file form readable by the mobile phone 14, such as an html file or an image file (JPEG file or the like).

In the intra-enterprise network 10, information items including documents prepared in various formats (file forms) and images within the enterprise are placed under unified management by the document management server 22 and the database server 24, and they are accumulated and stored in the database server 24.

The document management server 22 has a function to acquire from the database server 24, for the mobile phone 14 having accessed from outside the intra-enterprise network 10 via the communication network 12, the document requested by the mobile phone 14 and to convert that document into a format readable by the mobile phone 14. In this way, the bearer of the mobile phone 14 out of office is enabled to read on the mobile phone 14 intra-enterprise documents and images kept by the database server 24 in various formats.

Further, by accessing the document management server 22 from the mobile phone 14, a user of the mobile phone 14 can attach marking or a comment to any pertinent position in the document as sticker information, as well as can browse a document kept by the database server 24. This results in a substantially increased sphere of utilization of ECM solutions in sales activities, making them correspondingly more beneficial.

Although documents to which marking or a comment is to be attached from the mobile phone 14 will be limited to literal documents in the description of this embodiment of the invention, this attachment is not limited to literal documents but also applicable to other documents such as images.

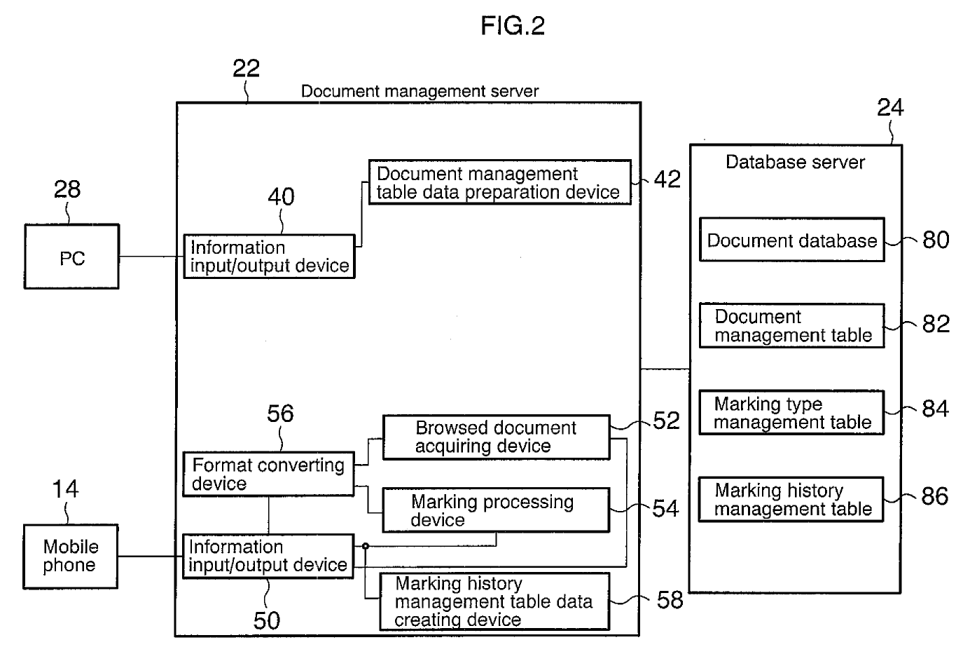

FIG. 2 is a system diagram showing a processing device related to the registration of a document with the PCs 28 in the intra-enterprise network 10, browse to the registered document and preparation of marking by the mobile phone 14.

First with reference to FIG. 2, particulars of processing by the processing device related to the registration of a document by a PC 28 in the intra-enterprise network 10 will be described. In this drawing, the PC 28 represents the personal computer used by a document browsing person who intends to register a document. The person actuates in the PC 28 a desired application for writing documents, writes a document and stores it in a desired format (file form). Then, in order to register that document with the database server 24, the person connects the PC 28 to the document management server 22, and takes a series of registration steps.

On the other hand, the document management server 22 is provided with an information input/output device 40, a document management table data preparation device 42 and so on, all related to the registration of documents.

The information input/output device 40 provides the PC 28 having accessed the document management server 22 with various guide screens for giving guidance on registration of documents, and acquires data on (the file of) the document to be registered (registered document) and information inputted by the document browsing person on the guide screen as information necessary for document management. The information input/output device 40 also performs user authentication to check whether or not any user trying to access the document management server 22 is authorized to access by first urging the user to input his or her password and any other required information. Only the users recognized as being authorized to access are allowed to register documents.

The document management table data preparation device 42, on the basis of the information inputted from the PC 28 and acquired by the information input/output device 40, prepares data for a document management table 82 to be described afterwards. The data for the document management table 82, together with files of registered documents, are sent from the document management server 22 to the database server 24, and each set of data is stored as a document management table 82 by the database server 24. The files of registered documents are stored into a document database 80 of the database server 24.

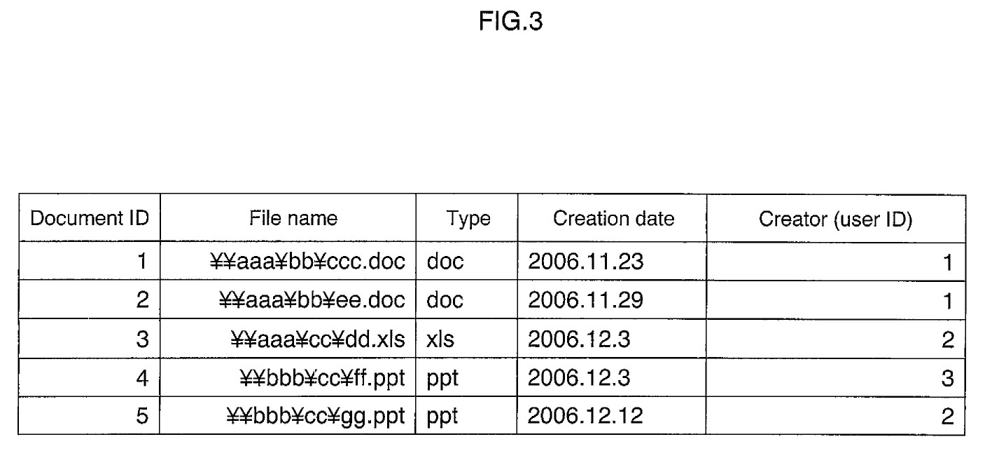

Now, the data structure of the document management table 82 will be described. FIG. 3 shows a typical data structure of the document management table 82. As shown in this drawing, a set of records per registered document comprises “Document ID”, “File name”, “Type”, “Creation date” and “Creator”, which make up a set of data of each field.

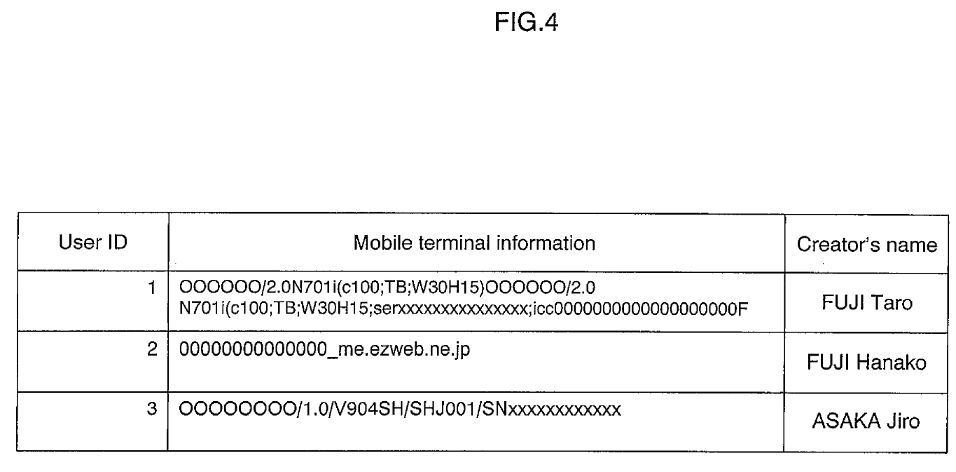

The “Document ID” is an ID number datum for easy identification of a registered document; the “File name”, one representing the address on the memory in which the pertinent registered document is stored; and the “Type”, one indicating the file form (format) of the pertinent registered document. The “Creation date” is a datum indicating the day on which the pertinent registered document was created (or was registered) and the “Creator”, a datum of ID number (user ID) assigned in advance to the person having created the pertinent registered document. User IDs are created in advance to constitute a creator management table as shown in FIG. 4 (dispensed with in FIG. 2) and managed by the database server 24, and for each individual user a set of data for the fields “User ID”, “Mobile terminal information” and “Creator's name” constitute a set of records. The “Mobile terminal information” datum, to be used as authenticating information for certifying the access authorization of the user when he or she accesses the document management server 22 from the mobile phone 14, is registered in advance for each individual user and managed in the creator management table of FIG. 4.

Data in each field of the document management table 82 are automatically created by the document management table data preparation device 42 of the document management server 22 when the document browsing person attempts to register a document from his or her PC 28 (as the “Creator”, for instance authenticating information is used), and added as records in the document management table 82.

On the other hand, the document management server 22 is provided with an information input/output device 50, a browsed document acquiring device 52, a marking processing device 54, a format converting device 56 and so forth all related to browsing the registered documents and creation of marking from the mobile phone 14.

The information input/output device 50 provides the mobile phone 14 having been connected to the document management server 22 with guide screens for giving guidance on browsing and altering registered documents, and acquires information inputted by the document browsing person from the mobile phone 14 on the guide screen as information necessary for browsing or altering the document. The information input/output device 50 also performs user authentication to check whether or not the user having accessed the document management server 22 is authorized to access by first urging the user to input his or her password and any other required information. Only the users recognized as being authorized to access are allowed to browse and update the registered documents.

Whereas processing particulars of the browsed document acquiring device 52 and the marking processing device 54 will be described in detail afterwards. The browsed document acquiring device 52 is a device which acquires a registered document designated for browsing by the document browsing person from the database server 24, on the basis of the information inputted from the mobile phone 14 and acquired by the information input/output device 50. The marking processing device 54 is a device which enables, on the basis of the information inputted from the mobile phone 14 and acquired by the information input/output device 50, to create marking designated by the document browsing person on the registered document currently being browsed by the person.

The format converting device 56, when the registered document to be accessed acquired by the browsed document acquiring device 52 or the document or the like on which marking has been created by the marking processing device 54 is to be displayed on the mobile phone 14 (the display device of the mobile phone 14), converts the document that may be created in an arbitrary format (file form) into a format browsable by the mobile phone 14, such as an html file or an image file (JPGE, GIF or the like). By transmitting this converted file to the mobile phone 14 via the information input/output device 50, a document in an arbitrary format can be browsed on the mobile phone 14.

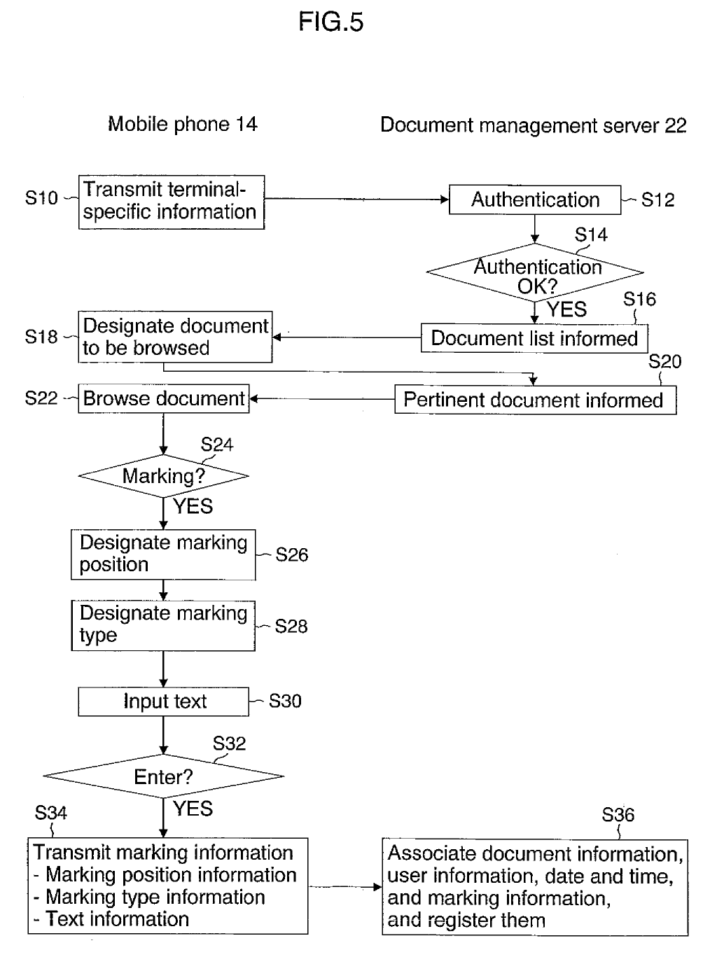

FIG. 5 is a sequence chart showing in a time series processing of marking in a random position in a browsed document from the mobile phone 14 manipulated by the document browsing person.

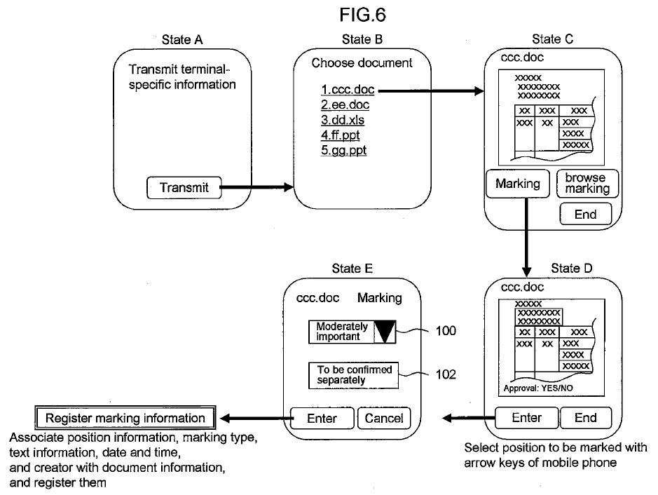

First, the document browsing person establishes connection from his or her mobile phone 14 to the document management server 22 (step S10). For connection to the document management server 22, the mobile phone 14 transmits mobile terminal information to the document management server 22. State A of FIG. 6 shows the display screen on the display device of the mobile phone 14 then.

The document management server 22 collates the mobile terminal information acquired by the information input/output device 40 and the creator management table of FIG. 4 stored in the database server 24 with each other to perform user authentication to check whether or not the document browsing person having attempted access is duly authorized to access (step S12). It then determines whether or not the user authentication has been properly accomplished (step S14); if it is determined NO, the user will be prohibited from access or, if it is determined YES, will be allowed access, and a document list screen for selection of the document to be displayed is transmitted to the PC 28 (step S16).

The document browsing person designates the document to be browsed on the basis of the list of documents displayed on the display device of the mobile phone 14 (step S18). State B of FIG. 6 shows the list of documents displayed on the display device of the mobile phone 14. The document management server 22 displays the designated document on the mobile phone 14 (step S20), and the designated document is displayed on the display device of the mobile phone 14 as shown in State C of FIG. 6 (step S22). The document displayed hereupon is supposed to have no marking created on it.

Then, the document browsing person designates from the mobile phone 14 whether or not marking is to be executed on the browsed document (step S24). Designation to execute marking is accomplished by pressing an operation button matching “Marking” as shown in State C of FIG. 6.

When the document browsing person presses the operation button matching “Marking”, a rectangle which is the object for marking in this embodiment is displayed overlapping the browsed document. The document browsing person, using the cross key of the mobile phone 14 or the like, shifts the rectangle for marking to the desired marking position (step S26). Although the size of the rectangle is fixed here, it may be altered to any desired size.

When the document browsing person presses an operation button matching “Enter” shown in State D of FIG. 6 and thereby finalizes the position of the rectangle for marking, a screen for determining the type of marking is displayed next as shown in State E of FIG. 6 (step S28).

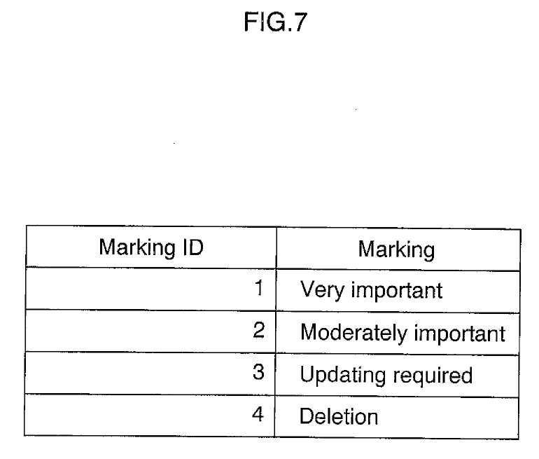

Marking types will be described hereupon. Marking types indicate levels of importance of marking, and there are four levels of importance from very important, moderately important, updating required and deletion. FIG. 7 shows the data structure of a marking type management table 84. A set of “Marking ID” and “Level of importance” constitute a set of records.

By aligning the cursor with a pull-down menu 100 by using the cross key and pressing a prescribed button on the screen shown in State E of FIG. 6, the marking type, namely the level of importance of marking can be selected. It is also possible to write a comment in by inputting text data to a blank 102 (step S30).

When designation of the marking type and the input of a comment have been completed, the marking is finalized by pressing an operation button matching “Enter” shown in State E of FIG. 6, and the mobile phone 14 transmits marking position information, marking type information and text information to the document management server 22 (step S34). In the document management server 22, marking history is automatically created by a marking history management table data creating device 58 on the basis of these items of information, and added as a record of a marking history management table 86 (step S36).

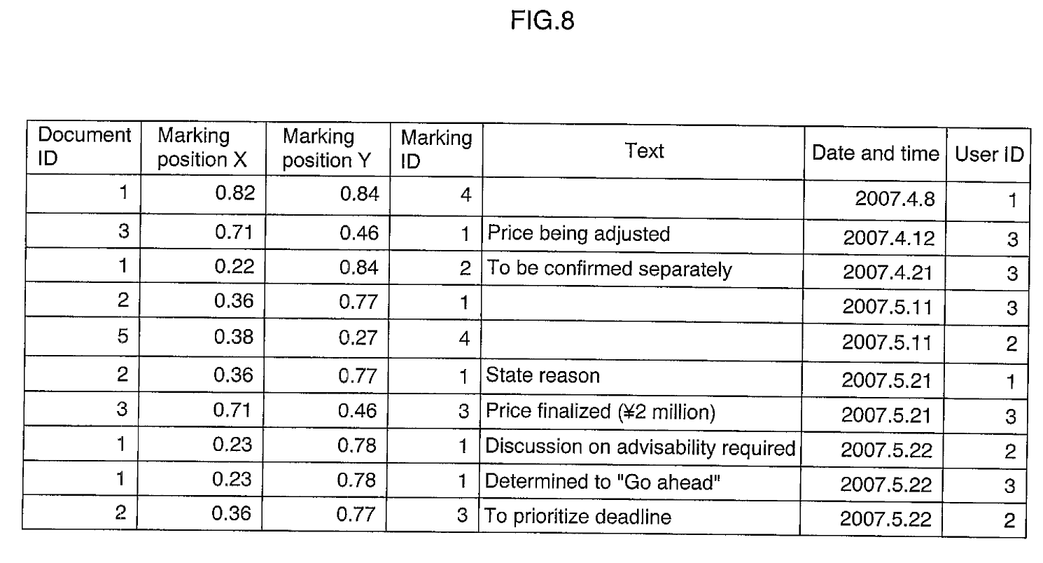

Hereupon, the data structure of the marking history management table 86 will be described. FIG. 8 shows a typical data structure of the marking history management table 86. As shown in this drawing, a set of data of fields “Document ID”, “Marking position X”, “Marking position Y”, “Marking ID”, “Text”, “Date and time of creation” and “User ID” constitute a set of records.

“Document ID” here is the datum of the ID of the browsed document; “Marking position X” and “Marking position Y”, the data of the coordinate position of the marking in the browsed document; “Marking ID”, the datum of the ID matching the level of importance of the marking designated at step S28; “Text”, the text data of the comment inputted at step 30; “Date and time of creation”, the date and time data of the creation of the marking; and “User ID”, the datum of the user ID based on the authenticating information used at step S12. Thus, the marking history is related to the browsed document to which the marking has applied when it is recorded.

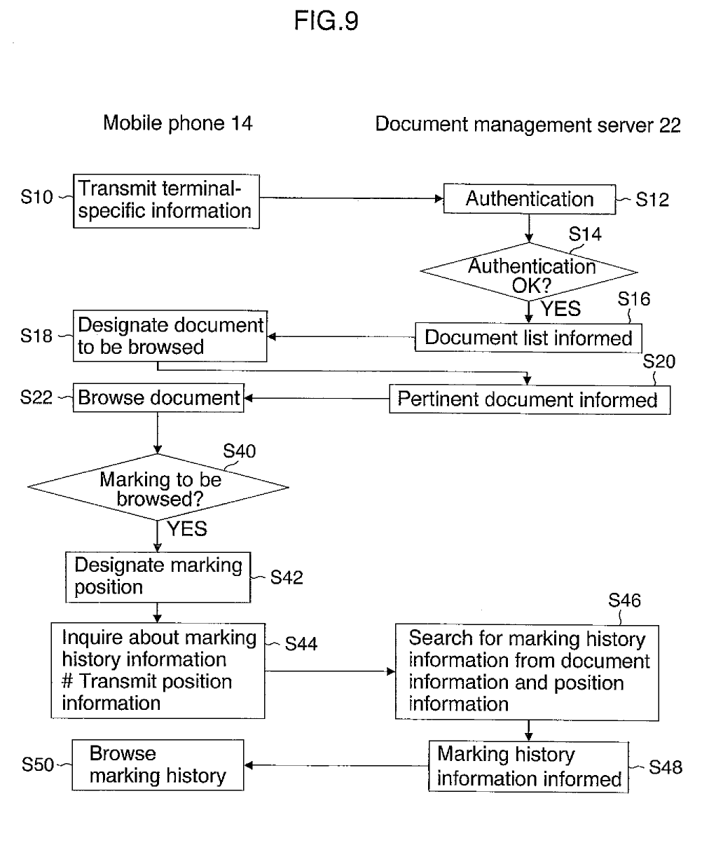

Next, browsing of marking on the browsed document will be described. FIG. 9 is a sequence chart showing in a time series processing of browsing marking in a document being browsed from the mobile phone 14 operated by the document browsing person. Parts in common with the sequence chart of FIG. 5 will be assigned respectively the same reference signs, and their detailed description will be dispensed with.

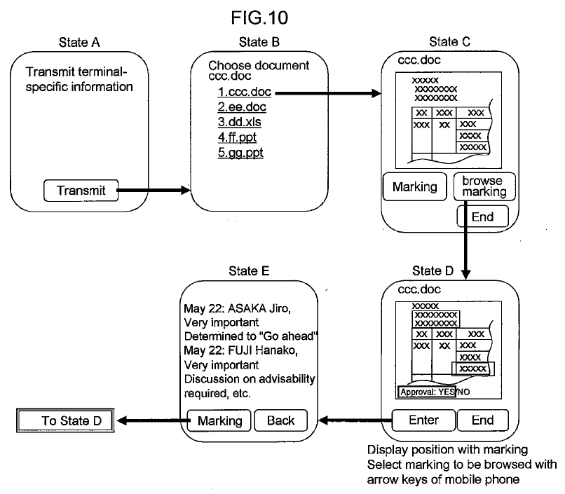

First, the document browsing person connects his or her mobile phone 14 to the document management server 22 (step S10). Connection to the document management server 22 is accomplished by transmitting mobile terminal information from the mobile phone 14 to the document management server 22. State A of FIG. 10 shows the display on the display device of the mobile phone 14 then.

The document management server 22 performs user authentication (step S12), determines whether or not the user authentication has been properly accomplished (step S14); if it is determined NO, the user will be prohibited from access or, if it is determined YES, will be allowed access, and a document list screen for selection of the document to be displayed is transmitted to the PC 28 (step S16).

The document browsing person designates the document desired to be browsed according to the list of documents displayed on the display device of the mobile phone 14 as shown in State B of FIG. 10 (step S18). The document management server 22 transmits the designated document to the mobile phone 14, at the same time acquires from the marking history management table 86 position information on the marking created on this document, and transmits it to the mobile phone 14 (step S20). On the basis of this information, the designated document is displayed on the display device of the mobile phone 14 as shown in State C of FIG. 10 (step S22).

Then, the document browsing person designates whether or not marking on the browsed document is to be browsed by the mobile phone 14 (step S40). Designation of execution of browsing of marking is accomplished by pressing an operation button matching “Browse marking” as shown in State C of FIG. 10.

When the document browsing person presses the operation button matching “Browse marking”, rectangles which are objects for marking are displayed, overlapping the browsed document, on the positions of marking as shown in State D of FIG. 10. The document browsing person, using the cross key of the mobile phone 14 or the like, selects the rectangle for marking which he or she desires to browse (step S42). The choice of the selected rectangle for marking is recognized by changes in the thickness of its lines and in its color and, when an operation button matching “Enter” shown in State D of FIG. 10 is pressed in the state in which the desired marking has been chosen, the marking to be browsed is designated.

When the marking to be browsed is designated, the mobile phone 14 makes an inquiry with the document management server 22 regarding the designated marking by using position information on the marking (step S44). The document management server 22 acquires information on the pertinent marking from the marking history management table 86 of the database server 24 according to the document information and the marking position information acquired by the information input/output device 50 (step S46). This marking information is transmitted to the mobile phone 14 by the information input/output device 50 (step S48).

The mobile phone 14 displays this transmitted information on its display device as shown in State E of FIG. 10 (step S50). In the illustration of this embodiment, a plurality of marking information items are displayed when a plurality of persons have attached markings in the same position of the browsed document, only the marking created by the currently browsing person may be displayed as well.

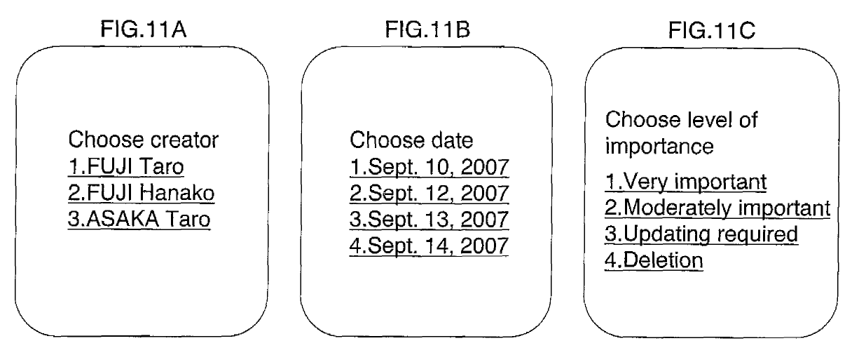

It is also acceptable to select the marking to be displayed after designating execution of browsing of marking at step S40. For instance, the creator may be designated by making a pertinent display on the display device of the mobile phone 14 as shown in FIG. 11A. In this case, only the marking created by the designated creator is displayed in the marking display shown in State D of FIG. 10. Similarly, the date of marking may be designated as shown in FIG. 11B, or the level of importance of marking may be designated as shown in FIG. 11C. In both cases, only the designated marking is displayed.

When all the markings are to be displayed at the same time, the markings may be differentiated in color by the date or the creator.

Further, the markings may as well be displayed in the order of date and time of creation. In this case, if the oldest marking is displayed first and one displayed marking is browsed at a time, the next oldest markings will be displayed in the forward order of date and time of creation. Conversely, the markings may as well be displayed in a backward order of creation.

In this way, when various documents under unified management are to be browsed from a mobile phone, marking can be created and later referenced as easily as putting a sticker onto a page and looking at it some time later. Further by designating marking to be browsed by the creator or the date of creation as parameters, only the required markings can be browsed efficiently.

While embodiments of the present invention have been explained in detail, the present invention is not limited to the above examples, needless to say, various improvements and modifications may be added without departing from the scope of the present invention.

For example, by providing a program causing a computer to perform functions of the document management server according to any of the embodiments and causing a computer on which the program is installed to execute the program, it is possible to implement the document management server according to the embodiment using a general-purpose computer. Further, by providing a recording medium on which the program is recorded, installing the program on a computer using the recording medium and causing the computer to execute the program, it is possible to implement the document management server according to any of the embodiments.

What is claimed is:

1. A document management server for managing documents in various formats arbitrarily created, comprising:
a device which allows a mobile terminal connected to the document management server via a communication network to browse an arbitrary document in the document management server;
a device which acquires sticker information on an electronic sticker attached to a document browsed by the mobile terminal; and
a device which manages the browsed document and the acquired sticker information associated with each other.

2. The document management server according to claim 1, wherein
the device which allows to browse documents comprises a device which enables the sticker information to be browsed together with the document.

3. The document management server according to claim 1, wherein
the sticker information includes at least one of a position, type, text information, name of creator, date and time of creation, and level of importance of the electronic sticker.

4. The document management server according to claim 3, wherein
the device which enables the sticker information to be browsed comprises at least one of: a device for browsing sticker information items on electronic sticker attached in the same position, a device for browsing sticker information items on electronic sticker attached by the same creator, a device for browsing sticker information items on electronic sticker with respect to each creator, a device for browsing sticker information items on electronic sticker attached on the same date of creation, a device for browsing sticker information items on electronic sticker in the order of the date of creation, and a device for browsing sticker information items on electronic sticker with respect to each level of importance.

5. A mobile terminal which is connected via a communication network to the document management server according to claim 1 and can browse an arbitrary document in the document management server, the mobile terminal comprising:
a device which attaches an electronic sticker to a browsed document; and
a device which outputs sticker information on the electronic sticker to the document management server.

6. The mobile terminal according to claim 5, wherein
the sticker information includes at least one of a position, type, text information, name of creator, date and time of creation, and level of importance of the electronic sticker.

7. A document management system, comprising:
a document management server for managing documents in various formats arbitrarily created, which comprises:
a device which allows a mobile terminal connected to the document management server via a communication network to browse an arbitrary document in the document management server;
a device which acquires sticker information on an electronic sticker attached to a document browsed by the mobile terminal; and
a device which manages the browsed document and the acquired sticker information associated with each other, and
a mobile terminal connected via a communication network to the document management server and browse an arbitrary document in the document management server, which comprises:
a device which attaches an electronic sticker to a browsed document; and
a device which outputs sticker information on the electronic sticker to the document management server.
